(19) United States
(12) Patent Application Publication
(10) Pub. No.: US 2008/0270388 A1
(43) Pub. Date: Oct. 30, 2008

(54) Method for providing keyword based on keyword providing range and system thereof

(75) Inventors: Wu Sic WEE, Yongin (KR); Minuk Kim, Seoul (KR)

Correspondence Address: EDWARDS ANGELL PALMER & DODGE LLP, P.O. BOX 55874, BOSTON, MA, 02205, US

(73) Assignee: NHN CORPORATION, Seongnam (KR)

(21) Appl. No.: 12/108,634

(22) Filed: Apr. 24, 2008

(30) Foreign Application Priority Data
Apr. 26, 2007 (KR) 10-2007-0040783

(51) Int. Cl. G06F 17/30

(52) U.S. Cl. 707/5; 707/E17.108

(57) ABSTRACT

A method of providing a keyword includes: receiving a query from a user; setting, according to user's selection, a keyword providing range with respect to the query; and providing a representative keyword or a tail keyword with respect to the query based on the keyword providing range.

### CROSS-REFERENCE TO RELATED APPLICATION

This application claims the benefit of Korean Patent Application No. 10-2007-0040783, filed on Apr. 26, 2007, the entire disclosure of which is incorporated herein by reference.

### BACKGROUND

1. Technical Field

The present invention relates to a method and system of providing a keyword based on a keyword providing range, and more particularly, to a method and system which can provide a representative keyword or a tail keyword with respect to a query entered by a user by a keyword providing range set, according to user's selection, with respect to the query.

2. Background Art

Methods for providing a keyword to a user have been proposed. In the methods, a keyword is provided only when the keyword accurately matches that entered by the user. The methods, however, have disadvantages. For example, the methods cannot provide a keyword desired by a user if there is no accurately-matched keyword. Also, when there is no matched keyword, the methods cannot perform a matching advertisement based on the keyword. In addition, since the methods simply provide only a search result with respect to the keyword matching an entered query, a keyword search result is limited and the scope of providable advertisement is, in turn, limited. Moreover, when the user enters a broad query, too many search results may be provided, which needs to limit a range of the keyword in order to provide the keyword actually desired by the user. Furthermore, a search range inconveniently needs to be narrowed by entering another query when the keyword search result desired by the user is not provided after the user enters the broad query.

Accordingly, there is a need for a method of adjusting a keyword providing range to provide a user with various keywords.

### BRIEF SUMMARY

An aspect of the present invention provides a method and system of providing a keyword which can provide a user with a representative keyword or a tail keyword with respect to a query entered by the user by setting, according to user's selection, a keyword providing range with respect to the query.

Another aspect of the present invention provides a method and system of providing a keyword which can provide a user with a representative keyword or a tail keyword with respect to a query entered by the user by analyzing a pattern of the query entered by the user and setting an option of retrieving the representative keyword or the tail keyword with respect to a specific keyword.

Still another aspect of the present invention provides a method and system of providing a keyword which can provide a user with a representative keyword with respect to a query entered by the user when a keyword providing range to provide the representative keyword or a tail keyword is set as a representative keyword providing range by the user.

Still further another aspect of the present invention provides a method and system of providing a keyword which can provide a user with a tail keyword with respect to a query entered by the user when a keyword providing range to provide a representative keyword or the tail keyword is set as a tail keyword providing range by the user.

A further aspect of the present invention provides a method of providing a keyword, the method including: receiving a query from a user; setting, according to user's selection, a keyword providing range with respect to the query; and providing a representative keyword or a tail keyword with respect to the query based on the keyword providing range.

A still further aspect of the present invention, provides a system for providing a keyword, the system including: a receiving component configured to receive, from a user, a query or a keyword providing range with respect to the query; a setting component configured to set the keyword providing range with respect to the query; and a providing component configured to provide a representative keyword or a tail keyword with respect to the query based on the keyword providing range.

Additional aspects, features, and/or advantages of the invention will be set forth in part in the description which follows and, in part, will be apparent from the description, or may be learned by practice of the invention.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates an interoperation relation between a system for providing a keyword and a user terminal according to an exemplary embodiment of the present invention;

FIG. 2 is a diagram illustrating the configuration of a system for providing a keyword according to an exemplary embodiment of the present invention;

FIG. 3 illustrates an example of a representative keyword provided by setting a keyword providing range according to an exemplary embodiment of the present invention;

FIG. 4 illustrates an example of tail keywords provided by setting a keyword providing range according to an exemplary embodiment of the present invention; and

FIG. 5 is a flowchart illustrating a method of providing a keyword according to an exemplary embodiment of the present invention.

### DETAILED DESCRIPTION OF EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

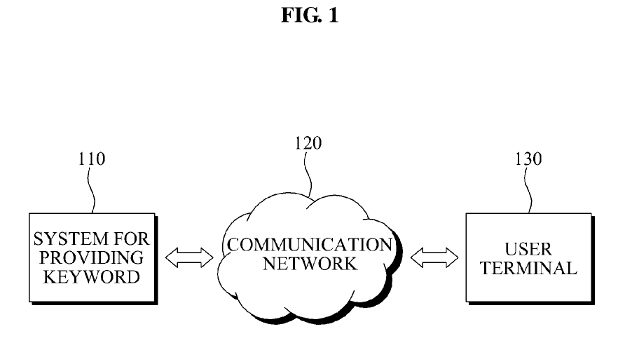

FIG. 1 illustrates an interoperation relation between a system 110 for providing a keyword and a user terminal according to an exemplary embodiment of the present invention.

Referring to FIG. 1, the system 110 for providing a keyword receives a query entered by a user from a user terminal 130 accessed via a communication network 130. The system 110 analyzes a pattern with respect to the query entered by the user, and retrieves a representative keyword or an enhanced keyword using an additionally-entered query after a specific query is entered based on the analyzed pattern. The term representative keyword used herein is a keyword being generally and widely used, and the term tail keyword used herein is a keyword added to the representative keyword. For example, when the representative keyword is ‘Nike’, the tail keyword may include ‘Nike shoes, Nike store, Nike clothes’ and the like.

When the query entered by the user is a representative keyword, the system 110 may provide a sub keyword or sub keywords associated with the representative keyword based on a keyword recommendation logic. In the system 110, a keyword providing range that enables the tail keyword with respect to a specific keyword to be set from the user terminal 130 is adjusted by the user. The system 110 sets the keyword providing range with respect to the specific keyword for providing the keyword.

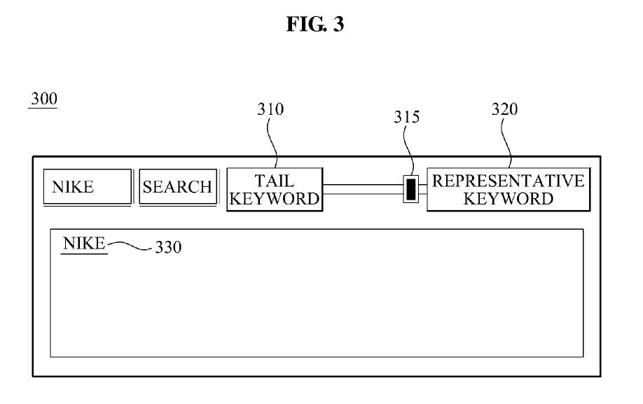

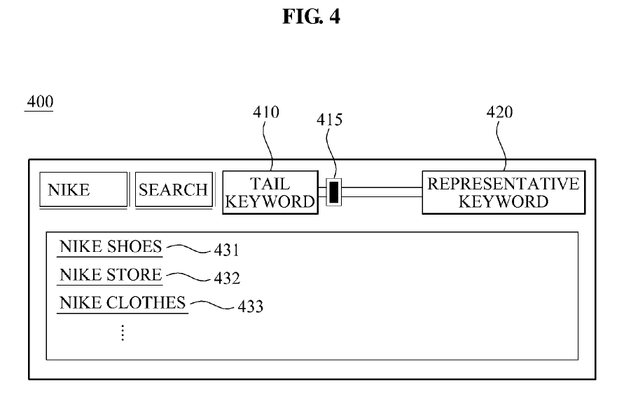

When the query is received from the user, the system 110 provides the user terminal 130 with an option of retrieving the representative keyword or the tail keyword as a keyword search result. In the user terminal 130, the keyword providing range may be adjusted by the user. The user can make a request for operation of control bars 315 and 415 illustrated in FIG. 3 and FIG. 4.

Based on the keyword providing range, the system 110 provides the user with the representative keyword or the tail keyword with respect to the query entered by the user using the user terminal 130.

As an example, when the query entered by the user is ‘Nike’, and the option retrieved by the user is the representative keyword, the system 110 may provide the user with ‘Nike’ as the representative keyword using the user terminal 130.

As another example, when the query entered by the user is ‘Nike’, and the option retrieved by the user is the tail keyword, the system 110 may provide the user with ‘Nike shoes, Nike store, Nike clothes’ and the like as the tail keyword using the user terminal 130.

As described above, by providing the option, the system 110 can provide the representative keyword or the tail keyword.

Therefore, with the system 110 according to the present invention, users can easily find the tail keyword, and user's interest in keyword search the number of clicks for the tail keyword can increase.

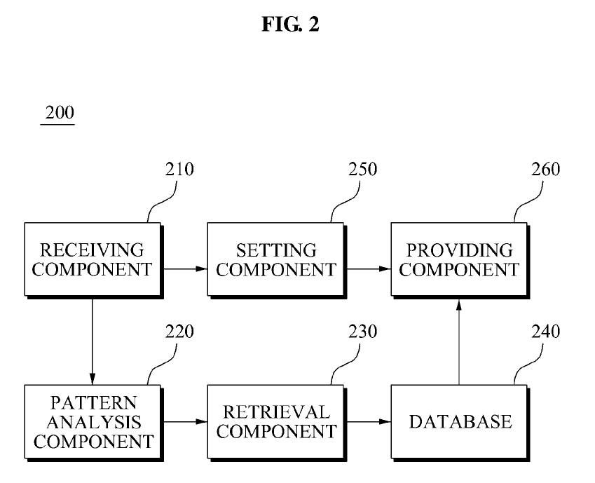

FIG. 2 is a diagram illustrating the configuration of a system for providing a keyword according to an exemplary embodiment of the present invention.

Referring to FIG. 2, the system 200 for providing a keyword includes a receiving component 210, a pattern analysis component 220, a retrieval component 230, a database 240, a setting component 250, and a providing component 260.

The receiving component 210 receives a query from a user. For example, the receiving component 210 may receive a query ‘Nike’ from the user.

Also, the receiving component 210 receives, from the user, a keyword providing range with respect to the query. For example, when an option for adjusting the keyword providing range with respect to the query is included, the receiving component 210 may receive, from the user, the keyword providing range adjusted by operation of an adjustment device. When the option is provided to be adjusted by operation of control bars 315 and 415, e.g., slide bars as illustrated in FIG. 3 and FIG. 4, the receiving component 210 may receive the keyword providing range with respect to the query, the keyword providing range being adjusted based operation of the control bars 315 and 415 by the user.

As an example, when the user intends to be provided with a representative keyword, the receiving component 210 may receive the keyword providing range with respect to the query for providing the representative keyword by moving the control bar to a representative keyword side.

As another example, when the user intends to be provided with the tail keyword, the receiving component 210 may receive the keyword providing range with respect to the query for providing the tail keyword by moving the control bar to a tail keyword side.

The pattern analysis component 220 analyzes the pattern of user's query. As an example, when the user uses a fixed Internet Protocol (IP) address, the pattern analysis component 220 analyzes a query pattern of the fixed IP address. As another example, when the user is a logged-in user, the pattern analysis component 220 analyzes a query pattern of the logged-in user.

The retrieval component 230 retrieves the representative keyword or the tail keyword based on the analyzed query pattern of the user. For example, when the analyzed query pattern shows that the query ‘Nike’ is entered by the user and a query including ‘Nike shoes, Nike store, Nike clothes’ and the like is subsequently entered, the retrieval component 230 may retrieve ‘Nike’ as the representative keyword, and may retrieve ‘Nike shoes, Nike store, Nike clothes’ and the like as the tail keyword.

The database 240 records and stores the representative keyword or the tail keyword retrieved based on the analyzed query pattern with respect to the query entered by the user.

The setting component 250 sets the keyword providing range with respect to the query entered by the user. Specifically, the setting component 250 sets the keyword providing range by deciding whether to provide the representative keyword or the tail keyword according to the option for the keyword providing range set with respect to the query entered by the user.

As illustrated in FIG. 3 as an example, when a request for operation of the control bar 315 to be moved to a side of a representative keyword 320 is received from the user, the setting component 250 may set the keyword providing range so that the representative keyword with respect to the entered query may be provided.

As illustrated in FIG. 4 as another example, when a request for operation of the control bar 415 to be moved to a side of a tail keyword 410 is received from the user, the setting component 250 may set the keyword providing range so that the tail keyword with respect to the entered query may be provided.

The providing component 260 provides the representative keyword or the tail keyword with respect to the query based on the keyword providing range. Specifically, the providing component 260 extracts, from the database 240, the representative keyword or the tail keyword with respect to the query based on the keyword providing range set by the setting component 250, and provides the user with the representative keyword or the tail keyword.

As an example, when the keyword providing range is set to provide the representative keyword with respect to the query, the providing component 260 may extract, from the database 240, the representative keyword corresponding to the query entered by the user, and provide the user with the representative keyword.

As another example, when the keyword providing range is set to provide the tail keyword with respect to the query, the providing component 260 may extract, from the database 240, the tail keyword corresponding to the query entered by the user, and provide the user with the tail keyword.

FIG. 3 illustrates an example of a representative keyword provided by setting a keyword providing range according to an exemplary embodiment of the present invention.

Referring to FIG. 3, when it is intended that a representative keyword with respect to a keyword entered by a user is provided, the receiving component 210 receives a user's request for operation of the control bar 315 to be moved to the side of the representative keyword 320. Also, the setting component 250 sets the keyword providing range based on the request for operation of the control bar 315 so that the representative keyword with respect to the entered query may be provided. Then, the providing component 260 provides, on a representative keyword providing screen 300, the user with the representative keyword corresponding to the query based on the keyword providing range. For instance, when a query ‘Nike’ is entered by the user and the control bar 315 for retrieving a tail keyword 310 or the representative keyword 320 with respect to the entered query is moved to the side of the representative keyword 320 by the user, the representative keyword providing screen 300 provides the user with ‘Nike’ 330 as the representative keyword.

As described above, when the keyword providing range, which may provide the representative keyword or the tail keyword, is set as a representative keyword providing range by the user, the system 200 may provide the user with the representative keyword.

FIG. 4 illustrates an example of tail keywords provided by setting a keyword providing range according to an exemplary embodiment of the present invention.

Referring to FIG. 4, when a query is entered by a user and a tail keyword with respect to the query is intended to be provided, the receiving component 210 receives a user's request for operation of the control bar 415 to be moved to the side of the tail keyword 410. Also, the setting component 250 sets the keyword providing range based on the request for operation of the control bar 415 so that the tail keyword(s) with respect to the entered query may be provided. Next, the providing component 260 provides, on a tail keyword providing screen 400, the tail keyword(s) corresponding to the query entered by the user based on the keyword providing range. For instance, when the query ‘Nike’ is entered by the user and the control bar 415 for retrieving the tail keyword 410 or a representative keyword 420 with respect to the entered query is moved to the side of the tail keyword 410 by the user, the tail keyword providing screen 400 provides Nike shoes 431, Nike store 432, and Nike clothes 433 as the tail keywords corresponding to the entered query.

As described above, when the keyword providing range, which may provide the representative keyword or the tail keyword, is set as a tail keyword providing range by the user, the system 200 may provide the user with the tail keyword.

Therefore, the system 200 may increase users' interest in a keyword search and may promote clicks of the tail keyword by providing a route so that the user may easily find the tail keyword, a keyword advertisement provider that provides an advertisement corresponding to the keyword may increase advertising profits with respect to a keyword advertisement.

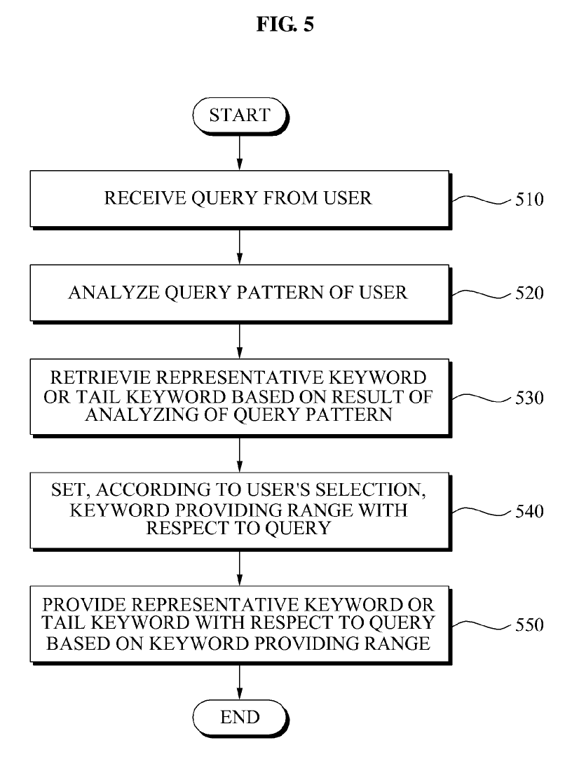

FIG. 5 is a flowchart illustrating a method of providing a keyword according to an exemplary embodiment of the present invention.

Referring to FIG. 5, in operation 510, the system for providing a keyword receives a query from a user. Specifically, for example, the system may receive a query such as ‘Nike’ from the user.

In operation 520, the system analyzes a query pattern of the user. As an example, when the user is a logged-in user, the system analyzes a query pattern of the logged in user. As another example, when the user uses a fixed IP address, the system analyzes a query pattern of the fixed IP address.

In operation 530, the system retrieves the representative keyword or the tail keyword based on the analyzed query pattern. Specifically, the system may analyze query pattern of many unspecified persons, and retrieve the representative keyword or the tail keyword with respect to the query.

For example, in operation 530, when the analyzed query pattern shows that the query ‘Nike’ is entered and a query including ‘Nike shoes, Nike store, Nike clothes’ and the like is subsequently entered, the system for providing a keyword may retrieve ‘Nike’ as the representative keyword, and retrieve ‘Nike shoes, Nike store, Nike clothes’ and the like as the tail keyword based on the pattern analysis result. Based on the analyzed query pattern, the system may retrieve the representative keyword or the tail keyword according to the correlation (association) among the queries.

In operation 540, the system sets, according to user's selection, a keyword providing range with respect to the query. Specifically, the system receives, from the user, a request for operation of a control bar for retrieving the representative keyword or the tail keyword and the keyword providing range with respect to the query set by the control bar.

As illustrated in FIG. 3 as an example, in operation 540, when a request for operation of the control bar 315 for retrieving the representative keyword is received from the user, the system may set, according to user's selection, the keyword providing range with respect to the query for retrieving the representative keyword.

As illustrated in FIG. 4 as another example, in operation 540, when a request for operation of the control bar 415 for retrieving the tail keyword is received from the user, the system for providing the keyword may set, according to user's selection, the keyword providing range with respect to the query for retrieving the tail keyword.

In operation 550, the system provides the representative keyword or the tail keyword with respect to the query based on the keyword providing range. That is, the system provides the user with the representative keyword or the tail keyword with respect to the query entered by the user by the keyword providing range set according to the user's selection.

As illustrated in FIG. 3 as an example, in operation 550, when the keyword providing range is set to be able to provide the representative keyword by moving the control bar 315 to the side of the representative keyword 320 by the user, the system provides the user with the representative keyword with respect to the query.

As illustrated in FIG. 4 as another example, in operation 550, when the keyword providing range is set to be able to provide the tail keyword by moving the control bar 415 to the side of the tail keyword 410 by the user, the system provides the user with the tail keyword with respect to the query.

As described above, the methods of providing a keyword according to the present invention may provide the user with the representative keyword or the tail keyword corresponding to the entered query by the keyword providing range set with respect to the query entered from the user.

Accordingly, the methods of providing a keyword according to the present invention enables the user to easily search for the tail keyword and increases the number of clicks of the tail keyword, thereby selling many tail keywords as an advertisement keyword.

In a further aspect, the methods according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

As described above, the present invention provides methods and systems provide advantages including the following. The methods and systems can provide a user with: a representative keyword or a tail keyword by setting a keyword providing range with respect to the query entered from the user; a representative keyword or a tail keyword with respect to a query entered by the user by analyzing a pattern of the query entered by the user and setting an option of retrieving the representative keyword or the tail keyword with respect to a specific keyword; a representative keyword with respect to a query entered by the user when a keyword providing range to provide the representative keyword or a tail keyword is set as a representative keyword providing range by the user; and a tail keyword with respect to a query entered by the user when a keyword providing range to provide a representative keyword or the tail keyword is set as a tail keyword providing range by the user.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

1. A method of providing a keyword, the method comprising:
receiving a query from a user;
setting, according to user's selection, a keyword providing range with respect to the query; and
providing a representative keyword or a tail keyword with respect to the query based on the keyword providing range.

2. The method of claim 1, wherein, in setting the keyword providing range, the keyword providing range with respect to the query is set by providing the user with an option to adjust the keyword providing range for providing the representative keyword or the tail keyword.

3. The method of claim 1, further comprising:
analyzing a query pattern of the user; and
retrieving the representative keyword or the tail keyword based on the analyzed query pattern.

4. The method of claim 3, wherein, in analyzing the query pattern, when the user uses a fixed Internet Protocol (IP) address, a query pattern of the fixed IP address is analyzed.

5. The method of claim 3, wherein, in analyzing the query pattern, when the user is a logged-in user, a query pattern of the logged-in user is analyzed.

6. The method of claim 1, wherein, in setting the keyword providing range, a request for operation of a control bar for adjusting the keyword providing range is received from the user to set the keyword providing range with respect to the query.

7. The method of claim 1, wherein, in setting the keyword providing range, when a control bar for adjusting the keyword providing range for retrieving the representative keyword or the tail keyword is operated to move to a tail keyword side by the user, the keyword providing range is set to provide the tail keyword with respect to the query.

8. A computer-readable recording medium storing a program for implementing a method of providing a keyword, the method comprising:
receiving a query from a user;
setting, according to user's selection, a keyword providing range with respect to the query; and
providing a representative keyword or a tail keyword with respect to the query based on the keyword providing range.

9. A system for providing a keyword, the system comprising
a receiving component configured to receive, from a user, a query or a keyword providing range with respect to the query;
a setting component configured to set, according to user's selection, the keyword providing range with respect to the query; and
a providing component configured to provide a representative keyword or a tail keyword with respect to the query based on the keyword providing range.

10. The system of claim 9, wherein the setting component sets the keyword providing range with respect to the query by providing the user with an option to adjust the keyword providing range for providing the representative keyword or the tail keyword.

11. The system of claim 9, further comprising:
a pattern analysis component configured to analyze a query pattern of the user; and
a retrieval component configured to retrieve the representative keyword or the tail keyword based on the analyzed query pattern.

12. The system of claim 11, wherein, when the user uses a fixed IP address, the pattern analysis component analyzes a query pattern of the fixed IP address.

13. The system of claim 11, wherein, when the user is a logged-in user, the pattern analysis component analyzes a query pattern of the logged-in user.

14. The system of claim 9, wherein the receiving component receives, from the user, a request for operation of a control bar for adjusting the keyword providing range for retrieving the tail keyword or the representative keyword, and
the setting component sets the keyword providing range with respect to the query based on the operation information.

15. The system of claim 9, wherein the receiving component receives, from the user, a request for operation of a control bar for adjusting the keyword providing range for retrieving the representative keyword or the tail keyword to move to a tail keyword side, and
the setting component sets the keyword providing range to provide the tail keyword with respect to the query based on the operation of the control bar.
